(19) United States
(12) Patent Application Publication
(10) Pub. No.: US 2016/0037751 A1
(43) Pub. Date: Feb. 11, 2016

(54) COMPOSITE ROPE AND ELASTOMER PET TOY

(71) Applicant: C.B. Worldwide, Inc. dba Mammoth Pet Products, Mammoth Lakes, CA (US)

(72) Inventor: Charles A. Byrne, Mammoth Lakes, CA (US)

(21) Appl. No.: 14/818,525

(22) Filed: Aug. 5, 2015

Related U.S. Application Data
(60) Provisional application No. 62/034,161, filed on Aug. 7, 2014.

(51) Int. Cl. A01K 11/00

(52) U.S. Cl. CPC A01K 15/026

(57) ABSTRACT

A pet chew toy includes a composite structure having a first end opposite a second end. The composite structure includes a first plurality of pliable threads encasing and retaining at least a center portion of a first elongated elastomer. The composite structure including the first plurality of pliable threads and the first elongated elastomer are tied into a first knot near the first end. Also, the composite structure including the first plurality of pliable threads and the first elongated elastomer are tied into a second knot near the second end. The first elongated elastomer is elastic and deforms under pressure and thereafter returns to its original shape.

### CROSS-REFERENCE TO RELATED APPLICATIONS

This application claims priority to provisional application 62/034,161 filed on Aug. 7, 2014, the entire contents of which are hereby incorporated by reference.

### DESCRIPTION

1. Field of the Invention

The present invention generally relates to pet toys. More particularly, the present invention relates to a pet toy with a composite structure combining ropes, threads or fibers at least partially encasing and retaining elastomeric tubes or rods.

2. Background of the Invention

Pet toys are a huge industry in the marketplace. Companies that produce pet toys are always searching for new and innovative designs that would inspire one's pet to play with it. The present invention fulfills these needs and provides other related advantages.

### SUMMARY OF THE INVENTION

An exemplary embodiment of a pet chew toy includes a composite structure having a first end opposite a second end. The composite structure includes a first plurality of pliable threads encasing and retaining at least a center portion of a first elongated elastomer. The composite structure includes the first plurality of pliable threads and the first elongated elastomer which are tied into a first knot near the first end. Also, the composite structure includes the first plurality of pliable threads and the first elongated elastomer which are tied into a second knot near the second end. The first elongated elastomer is elastic and deforms under pressure and thereafter returns to its original shape.

The first elongated elastomer may be disposed as an inner core and the first plurality of pliable threads may be disposed as an outer shell. The pet chew toy may be generally bone-shaped.

The first elongated elastomer may comprise a cross-sectional shape of a solid circle, a solid triangle, a solid square or a solid rectangle. Alternatively, the first elongated elastomer may comprise a cross-sectional shape of a hollow circle, a hollow triangle, a hollow square or a hollow rectangle.

The first plurality of pliable threads at the first and second ends may be frayed exposing the first elongated elastomer. Or, the first plurality of pliable threads at the first and second ends may extend beyond the first elongated elastomer, where the first plurality of pliable threads at the first and second ends are tied to fully retain and encase the elongated elastomer.

The first plurality of pliable threads may comprise a weave or pattern disposed along at least the center portion. The weave or pattern may comprise a twill pattern, a herringbone pattern, a chevron pattern, or a basketweave pattern. The first plurality of pliable threads may be natural or synthetic fibers.

As shown in FIGS. 15-21, the composite structure may comprise only one first elongated elastomer. Alternatively, and not shown, the composite structure may comprise at least two plurality of pliable threads encasing respectively the center portion of the at least two elongated elastomers, where the at least two plurality of pliable threads and elongated elastomers are adjacently disposed and twisted with respect to one another at least along the center portion and are formed into the first and second knots. Alternatively, as shown in FIGS. 1-14, the composite structure may comprise at least three plurality of pliable threads encasing respectively the center portion of the at least three elongated elastomers, where the at least three plurality of pliable threads and elongated elastomers are adjacently disposed and twisted with respect to one another at least along the center portion and are formed into the first and second knots. Said differently, the composite structure may comprise a second plurality of pliable threads encasing and retaining at least a center portion of a second elongated elastomer, and a third plurality of pliable threads encasing and retaining at least a center portion of a third elongated elastomer, wherein the first, second and third plurality of pliable threads and elongated elastomers are disposed adjacent to each other and are adjacently formed into the first and second knots.

The center portion of the elongated elastomer may comprise a compressible squeaker.

The first elongated elastomer may comprise a flexible and resilient polymer. The elongated elastomer may comprise an elastic substance occurring naturally or produced synthetically. The elongated elastomer may comprise rubber, natural rubber, butyl rubber, thermal plastic rubber, silicone, neoprene or any combination or blend thereof.

The first plurality of pliable threads or the first elongated elastomer may be impregnated with an odor or a scent.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of an embodiment of a composite rope and elastomer pet toy;

FIG. 2 is a front elevation view of FIG. 1;

FIG. 3 is a rear elevation view of FIG. 1;

FIG. 4 is a top plan view of FIG. 1;

FIG. 5 is a bottom plan view of FIG. 1;

FIG. 6 is a left side elevation view of FIG. 1;

FIG. 7 is a right side elevation view of FIG. 1;

FIG. 8 is a perspective view of another embodiment of a composite rope and elastomer pet toy;

FIG. 9 is a front elevation view of FIG. 8;

FIG. 10 is a rear elevation view of FIG. 8;

FIG. 11 is a right side elevation view of FIG. 8;

FIG. 12 is a left side elevation view of FIG. 8;

FIG. 13 is a top plan view of FIG. 8; and

FIG. 14 is a bottom plan view of FIG. 8.

FIG. 15 is a perspective view of another embodiment of a composite rope and elastomer pet toy;

FIG. 16 is a front elevation view of FIG. 15;

FIG. 17 is a rear elevation view of FIG. 15;

FIG. 18 is a right side elevation view of FIG. 15;

FIG. 19 is a left side elevation view of FIG. 15;

FIG. 20 is a top plan view of FIG. 15; and

FIG. 21 is a bottom plan view of FIG. 15.

### DETAILED DESCRIPTION OF THE PREFERRED EMBODIMENTS

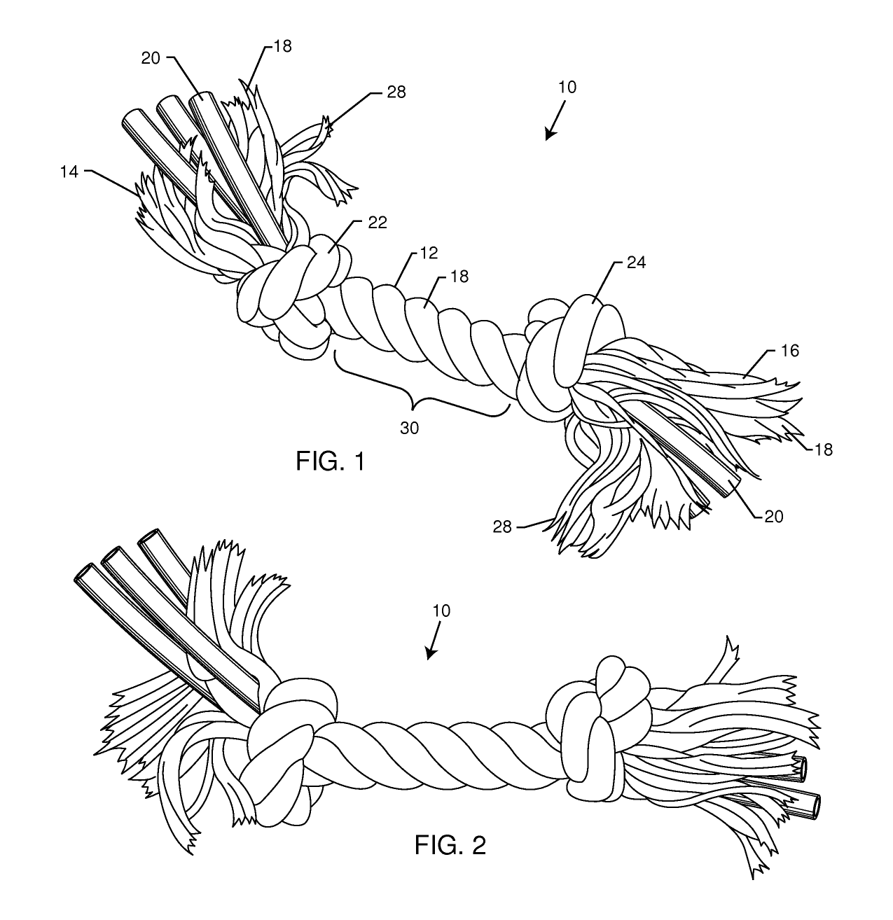

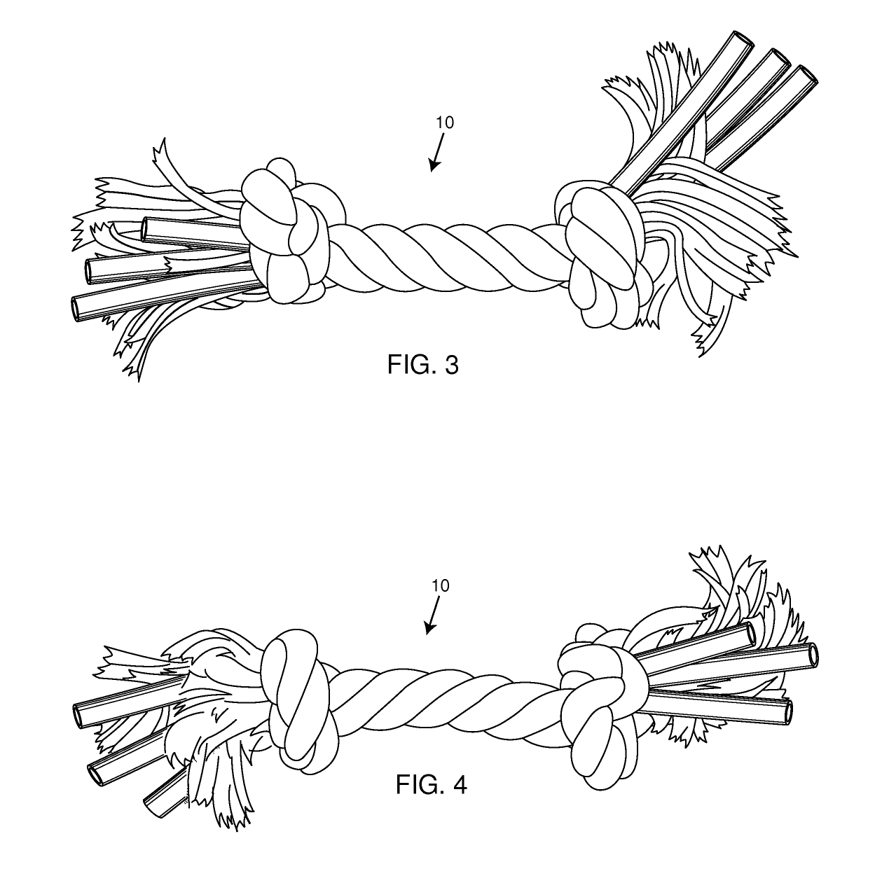

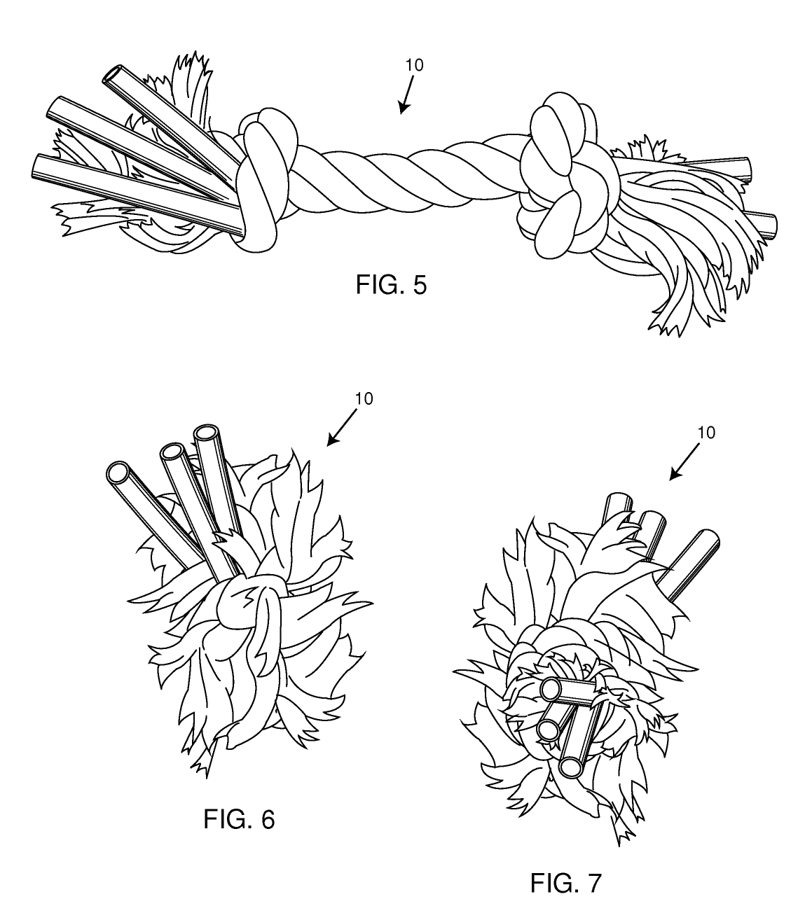

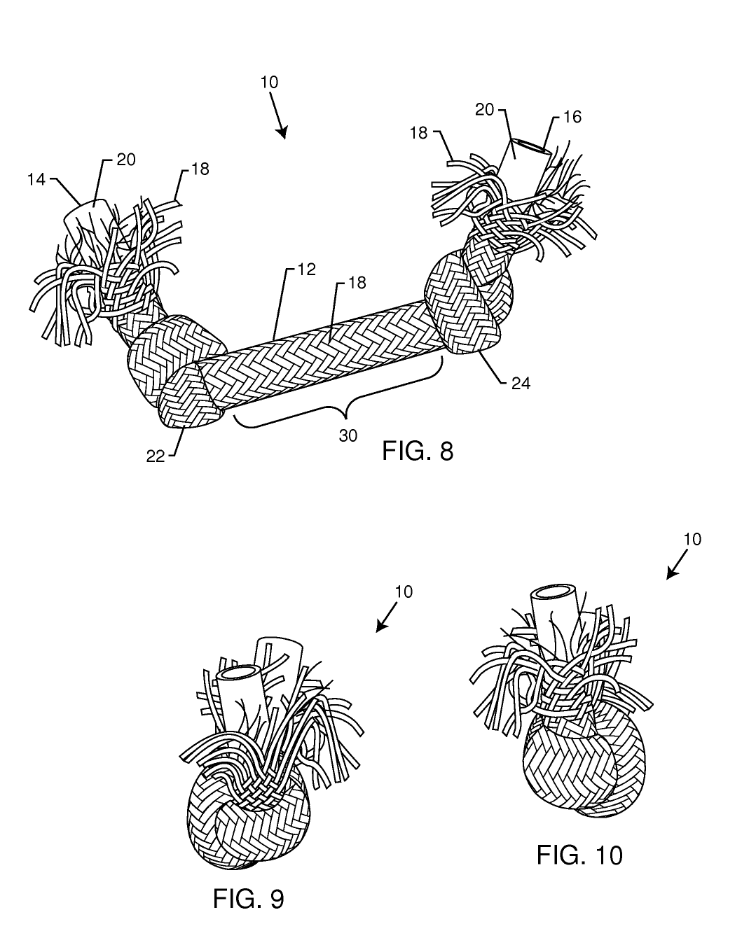

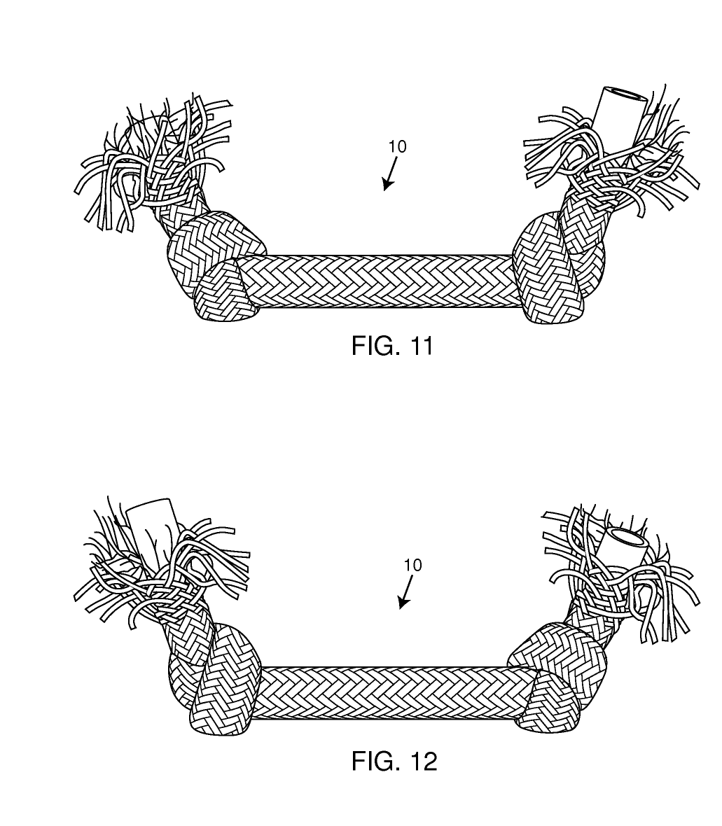

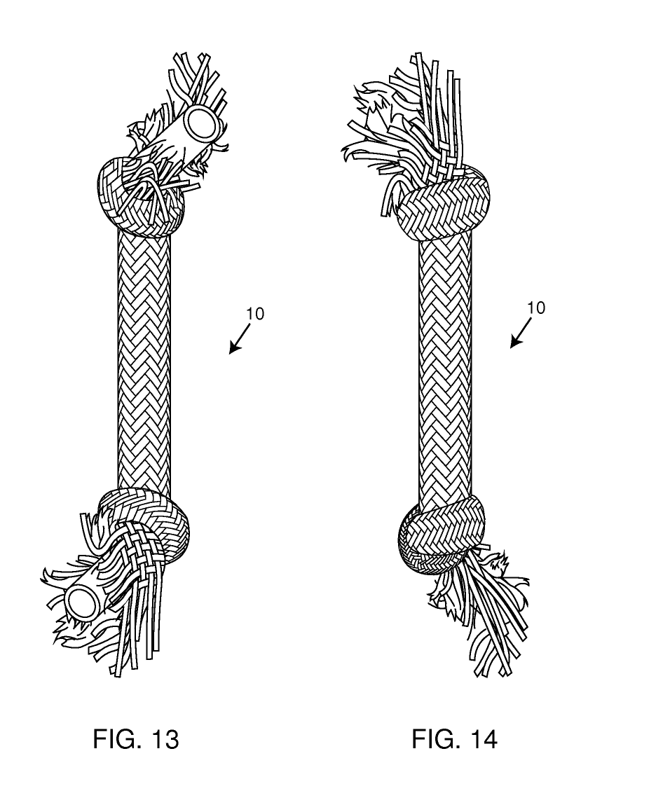

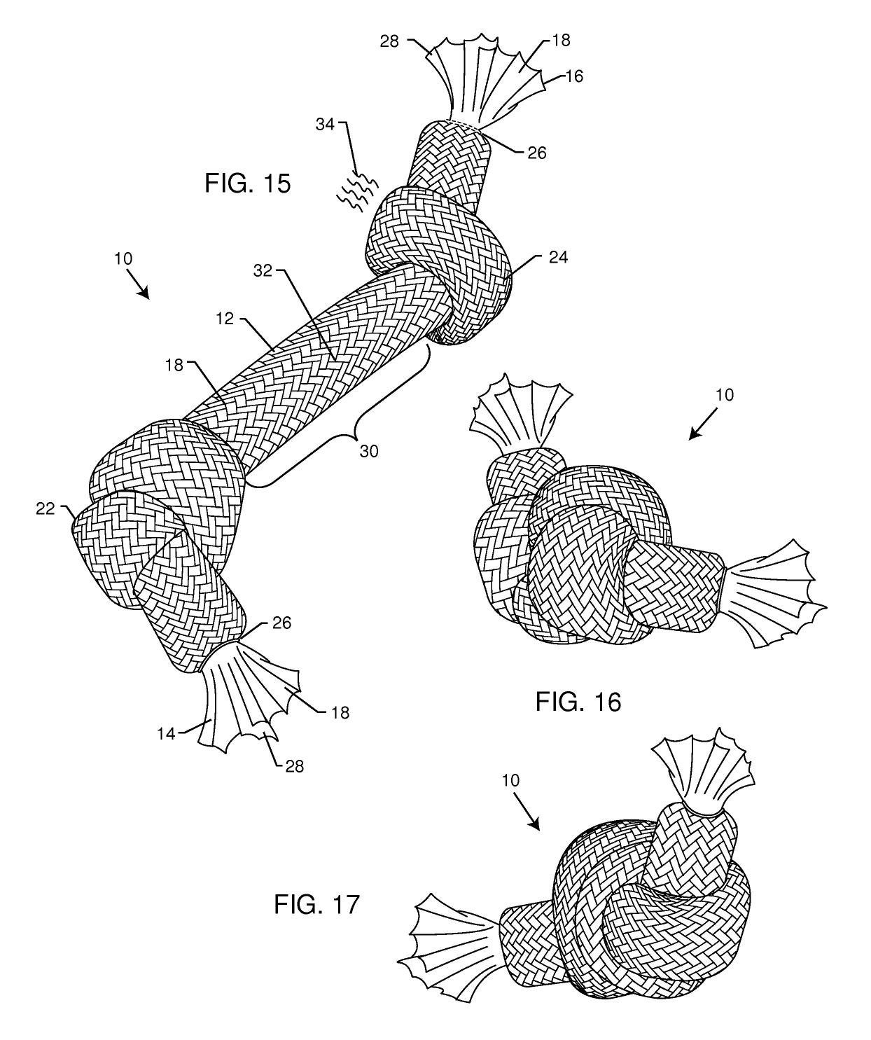

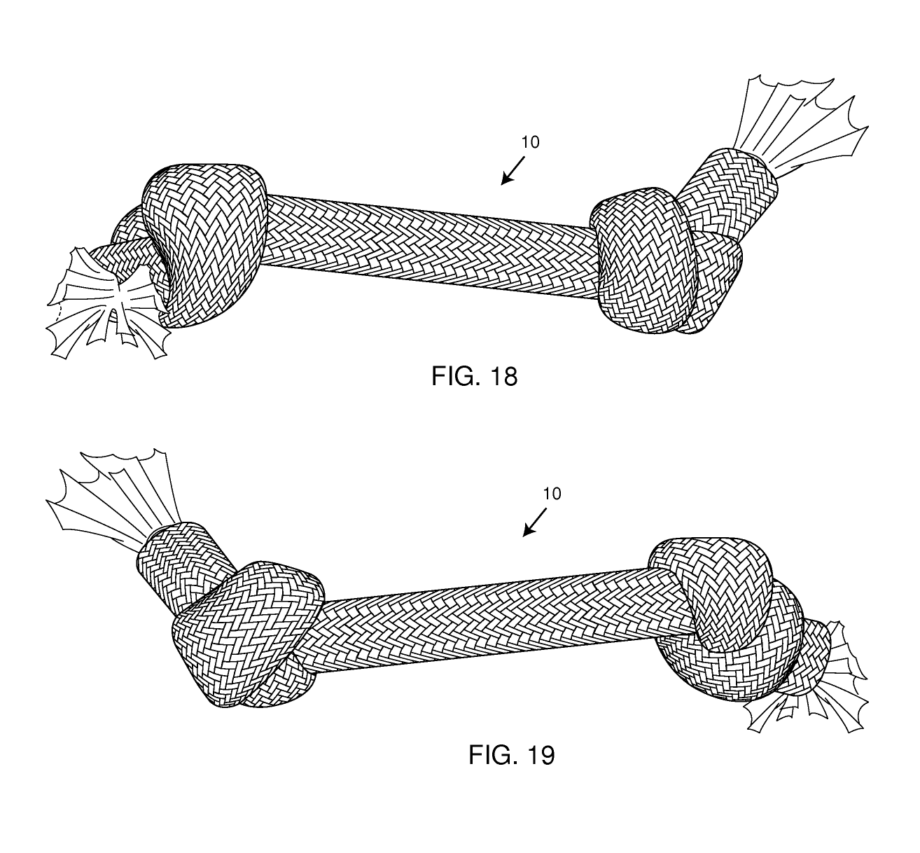

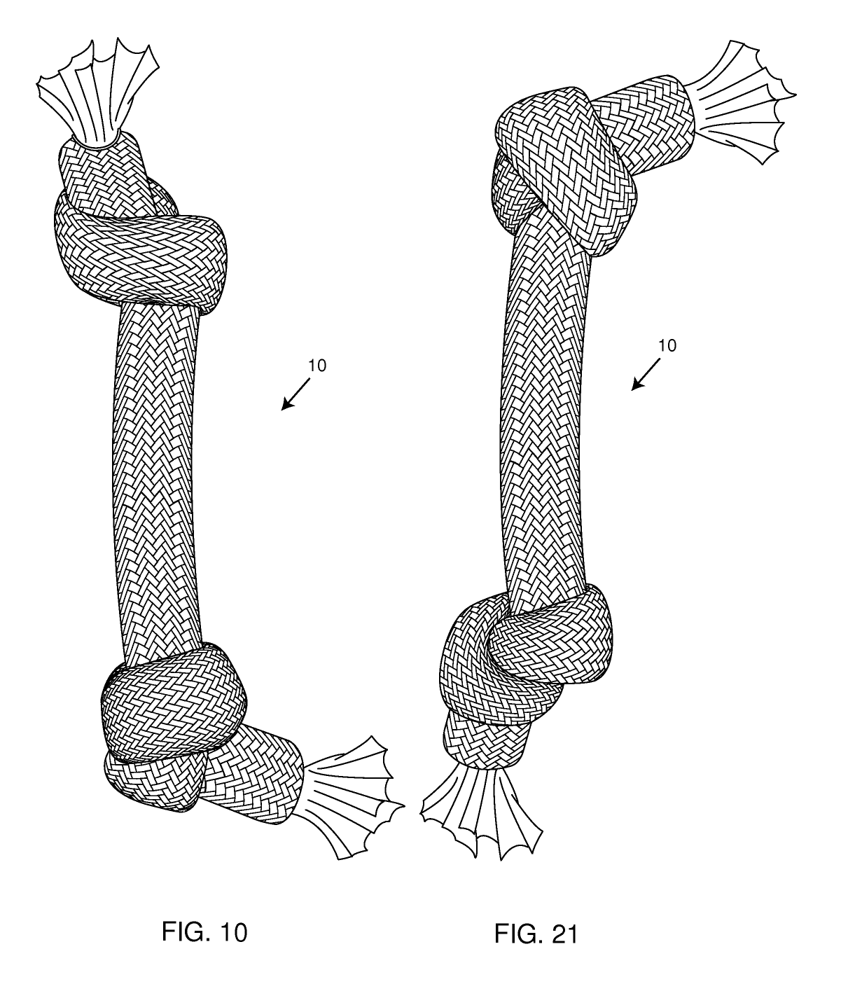

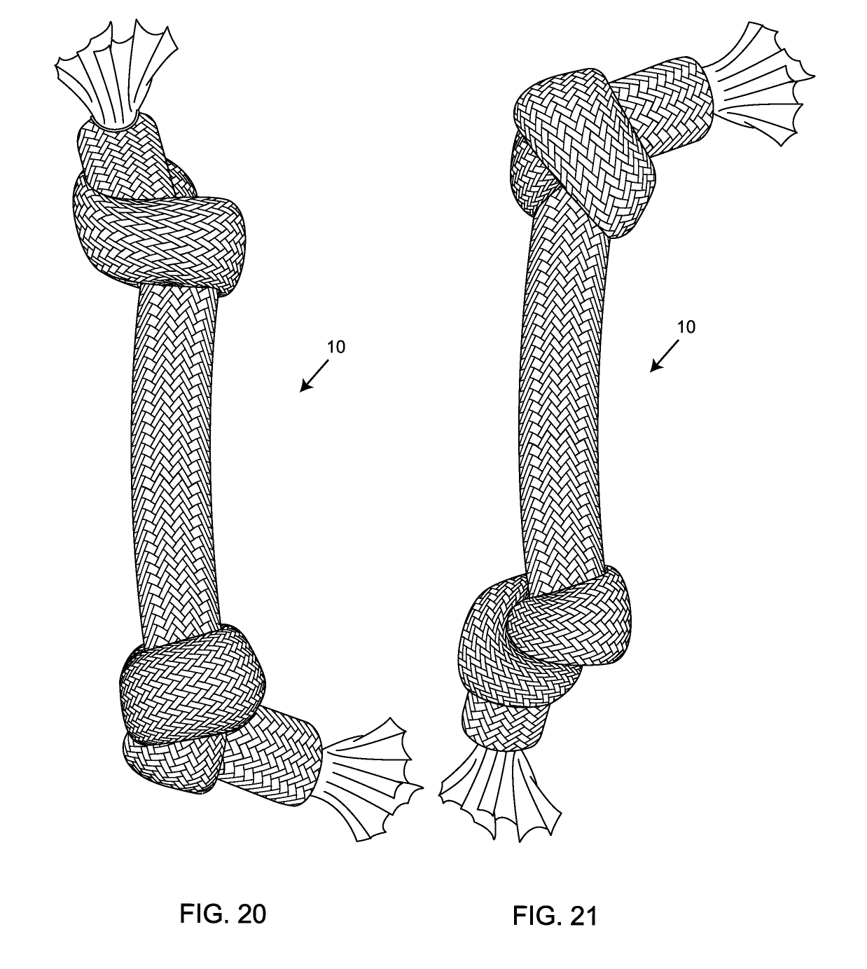

Three different embodiments of a pet chew toy 10 are disclosed. The first embodiment is shown in FIGS. 1-7. The second embodiment is shown in FIGS. 8-14. The third embodiment is shown in FIGS. 15-21. A composite structure 12 has a first end 14 opposite a second end 16. The composite structure 12 comprises a first plurality of pliable threads 18 encasing and retaining at least a center portion of a first elongated elastomer 20. The composite structure 12 includes the first plurality of pliable threads 18 and the first elongated elastomer 20 which are tied into a first knot 22 near the first end 14. Similarly, the composite structure 12 includes the first plurality of pliable threads 18 and the first elongated elastomer 20 which are tied into a second knot 24 near the second end 16. As can be seen in the various figures, the resulting structure of the pet chew toy 10 resembles a bone, or could be considered bone-shaped.

The elongated elastomer 20 is disposed as an inner core and the first plurality of pliable threads 18 are disposed as an outer shell. As seen in the figures, the threads 18 fully enclose and retain the elongated elastomer 20 within. The elongated elastomer 20 can take many shapes and sizes. For example, the first elongated elastomer 20 may have a cross-sectional shape of a solid circle, a solid triangle, a solid square or a solid rectangle. Alternatively, the first elongated elastomer 20 may have a cross-sectional shape of a hollow circle, a hollow triangle, a hollow square or a hollow rectangle. As is shown in the figures, the elastomers are hollow tubes, but it is understood by those skilled in the art that a variety of shapes and sizes may be used.

The elongated elastomer 20 is resilient and can deform under pressure to then bounce back to its original shape when the pressure is released. The elongated elastomer 20 can be made from a naturally occurring or synthetic material. For example, the elastomer 20 can be a natural rubber material or made as a butyl rubber or neoprene. The elastomer 20 can also be made from a flexible and resilient polymer. As is understood by those skilled in the art, the elastomer 20 can be made from a variety of materials.

In the embodiments shown in FIGS. 15-21 the distal ends of the threads extend beyond the ends of the elastomer. Then, the threads can be tied at location 26 such that only the frayed ends 28 of the plurality of pliable threads 18 are left. In production, the knots may be formed and then the elastomer ends cut or trimmed back such that the distal ends of the threads extend beyond the ends of the elastomer. The elastomer 20 is completely encased and cannot be seen from the outside. In other words, the first plurality of pliable threads 18 at the first 14 and second ends 16 extend beyond the first elongated elastomer 20, and the first plurality of pliable threads 18 at the first 14 and second ends 16 are tied to fully retain and encase the elongated elastomer 20. To the contrary, in the embodiments of FIGS. 1-14 the first plurality of pliable threads 18 at the first 14 and second ends 16 are frayed 28 exposing the first elongated elastomer 20.

The plurality of pliable threads 18 may be formed into a weave or pattern, such as a twill pattern, a herringbone pattern, a chevron pattern, a basketweave pattern or any other pattern known to those skilled in the art of patterns made from threads. Therefore, it is understood that a wide variety of patterns are capable of utilizing the present invention. Also, the plurality of pliable threads 18 may be natural or synthetic fibers. The fibers can form a rope or other rope-like structures. The fibers can also be course or soft. The plurality of pliable threads 18 can also be a fine cord of flax, cotton, or other fibrous material spun out to considerable length, especially when composed of two or more filaments twisted together. As can be seen a variety of materials may be used to comprise the plurality of pliable threads 18.

In the embodiments shown in FIGS. 15-21, the composite structure 12 comprises only one first elongated elastomer 20 that is encapsulated by the plurality of pliable threads 18. Contrasting this, the embodiments shown in FIGS. 1-14 show the composite structure 12 comprising at least three plurality of pliable threads 18 twisted about and encasing respectively at least a center portion 30 of at least three elongated elastomers 20.

Therefore, an number of elongated elastomers 20 and plurality of pliable threads 18 may be used, whether it is just one, two, three, or any other combination that can still be formed into a first knot 22 and a second knot 24. More specifically, the composite structure 12 may comprise a second plurality of pliable threads 18 encasing and retaining at least a center portion 30 of a second elongated elastomer 20, where the first and second plurality of pliable threads 18 and elongated elastomers 20 are disposed adjacent to each other and are adjacently formed into the first 22 and second knots 24. In another embodiment, the composite structure 12 may comprise a second plurality of pliable threads 18 encasing and retaining at least a center portion 30 of a second elongated elastomer 20, and a third plurality of pliable threads 18 encasing and retaining at least a center portion 30 of a third elongated elastomer 20, wherein the first, second and third plurality of pliable threads 18 and elongated elastomers 20 are disposed adjacent to each other and are adjacently formed into the first 22 and second knots 24.

In other embodiments, the center portion 30 of the elongated elastomer 20 may comprise a compressible squeaker 32. This is best shown in FIG. 15, but the squeaker 32 is hidden inside the hollow elastomer 20 so the squeaker 32 cannot be seen from the outside, but it can be disposed therein.

In other embodiments, the first plurality of pliable threads 18 or the first elongated elastomer 20 can be impregnated with an odor or scent 34 in techniques known to those skilled in the art. Alternatively, the elongated elastomer 20 or plurality of pliable threads 18 may be embedded with various flavoring or teeth cleaners/fresheners (such as sodium bicarbonate) 34 that the pet would like or would be beneficial to the pet's teeth or overall health. It is also possible to infuse the elongated elastomer 20 or plurality of pliable threads 18 with various vitamins or medicine that a particular pet could require.

All of the embodiments shown herein are bone-shaped, meaning the composite structure resembles a bone by having a first 22 and second knot 24. However, those skilled in the art will understand that the composite structure 12 could be formed in a multitude of knots, such as just one knot, or alternatively into three, four, five, six, or any number of knots by extending the length of the composite structure 12. Accordingly, a wide variety of shapes and designs can be accomplished by the teachings of the present invention.

Although several embodiments have been described in detail for purposes of illustration, various modifications may be made to each without departing from the scope and spirit of the invention. Accordingly, the invention is not to be limited, except as by the appended claims.

### NUMERALS

10 pet chew toy

12 composite structure

14 first end

16 second end

18 plurality of pliable threads

20 elongated elastomer

22 first knot

24 second knot

26 tied location

28 frayed ends

30 center portion

32 compressible squeeker

34 scent/odor/breath freshener/medicine

What is claimed is:

1. A pet chew toy, comprising:
a composite structure having a first end opposite a second end, where the composite structure comprises a first plurality of pliable threads encasing and retaining at least a center portion of a first elongated elastomer;
wherein the composite structure including the first plurality of pliable threads and the first elongated elastomer are tied into a first knot near the first end; and
wherein the composite structure including the first plurality of pliable threads and the first elongated elastomer are tied into a second knot near the second end.

2. The pet chew toy of claim 1, wherein the first elongated elastomer is disposed as an inner core and the first plurality of pliable threads is disposed as an outer shell.

3. The pet chew toy of claim 1, where the first elongated elastomer comprises a cross-sectional shape of a solid circle, a solid triangle, a solid square or a solid rectangle.

4. The pet chew toy of claim 1, where the first elongated elastomer comprises a cross-sectional shape of a hollow circle, a hollow triangle, a hollow square or a hollow rectangle.

5. The pet chew toy of claim 1, wherein the pet chew toy is generally bone-shaped.

6. The pet chew toy of claim 1, wherein the first plurality of pliable threads at the first and second ends are frayed exposing the first elongated elastomer.

7. The pet chew toy of claim 1, wherein the first plurality of pliable threads at the first and second ends extend beyond the first elongated elastomer, and where the first plurality of pliable threads at the first and second ends are tied to fully retain and encase the elongated elastomer.

8. The pet chew toy of claim 1, wherein the first elongated elastomer is elastic and deforms under pressure thereafter returning to its original shape.

9. The pet chew toy of claim 1, wherein the first elongated elastomer comprises a flexible and resilient polymer.

10. The pet chew toy of claim 1, wherein the elongated elastomer comprises an elastic substance occurring naturally or produced synthetically.

11. The pet chew toy of claim 1, wherein the elongated elastomer comprises rubber, natural rubber, butyl rubber, thermal plastic rubber, silicone, neoprene or any combination or blend thereof.

12. The pet chew toy of claim 1, wherein the first plurality of pliable threads comprises a weave or pattern disposed along at least the center portion.

13. The pet chew toy of claim 12, wherein the weave or pattern comprises a twill pattern, a herringbone pattern, a chevron pattern, or a basketweave pattern.

14. The pet chew toy of claim 1, wherein the first plurality of pliable threads are natural or synthetic fibers.

15. The pet chew toy of claim 1, wherein the composite structure comprises only one first elongated elastomer.

16. The pet chew toy of claim 1, wherein the composite structure comprises at least two plurality of pliable threads encasing respectively the center portion of the at least two elongated elastomers, where the at least two plurality of pliable threads and elongated elastomers are adjacently disposed and twisted with respect to one another at least along the center portion and are formed into the first and second knots.

17. The pet chew toy of claim 1, wherein the composite structure comprises at least three plurality of pliable threads encasing respectively the center portion of the at least three elongated elastomers, where the at least three plurality of pliable threads and elongated elastomers are adjacently disposed and twisted with respect to one another at least along the center portion and are formed into the first and second knots.

18. The pet chew toy of claim 1, wherein the composite structure comprises a second plurality of pliable threads encasing and retaining at least a center portion of a second elongated elastomer, and a third plurality of pliable threads encasing and retaining at least a center portion of a third elongated elastomer, wherein the first, second and third plurality of pliable threads and elongated elastomers are disposed adjacent to each other and are adjacently formed into the first and second knots.

19. The pet chew toy of claim 1, wherein the center portion of the elongated elastomer comprises a compressible squeaker.

20. The pet chew toy of claim 1, wherein the first plurality of pliable threads or the first elongated elastomer is impregnated with an odor or a scent.
